(19) United States
(12) Patent Application Publication
(10) Pub. No.: US 2008/0270216 A1
(43) Pub. Date: Oct. 30, 2008

(54) System and method for standards and governance evaluation framework

(75) Inventors: Jillian Munro, Maplewood, NJ (US); Ford Stewart, Maplewood, NJ (US); David Phelps, New York, NY (US)

Correspondence Address: MORGAN LEWIS & BOCKIUS LLP, 1111 PENNSYLVANIA AVENUE NW, WASHINGTON, DC, 20004, US

(73) Assignee: Lehman Brothers Inc., New York, NY (US)

(21) Appl. No.: 12/149,399

(22) Filed: Apr. 30, 2008

Related U.S. Application Data
(60) Provisional application No. 60/924,099, filed on Apr. 30, 2007.

(51) Int. Cl. G06Q 10/00

(52) U.S. Cl. 705/9; 705/7

(57) ABSTRACT

A system includes a standards inventory database to store at least one control model, the at least one control model including at least one control objective and one or more controls, wherein each of the one or more controls is related to at least one asset of an organization, a tests datastore to store one or more control tests to be applied to the at least one asset of the organization, each of the one or more controls being associated with at least one of the one or more control tests, and a server including a testing tool to evaluate each of the one or more controls using the at least one of the one or more control tests associated with each of the one or more controls and to assign a status to the one or more control tests, and a metrics engine to track performance metrics of each of the one or more controls based on the status of the one or more control tests to provide trends in compliance with the one or more controls.

This application claims the benefit of the U.S. Provisional Patent Application No. 60/924,099 filed on Apr. 30, 2007, which is hereby incorporated by reference.

### BACKGROUND OF THE INVENTION

1. Field of the Invention

The present invention relates to a system and method for standards and governance evaluation framework, and more particularly to a system and method for establishing an inventory of standards and policies, evaluating the level of compliance with the standards, and resolving identified exceptions to the standards.

2. Discussion of the Related Art

Standards, policies, and best practices (collectively referred to as “standards”) are used by organizations to guide and influence the behavior of its employees. However, inventory and evaluation systems for standards and policies include disparate and incongruent collections of standards. While existing systems attempt to organize the inventory of standards under broad categories and evaluate a level of compliance to the standards, the standards are disjointed and unconnected to the objects to which the standards apply. Further, these systems do not identify the groups or individuals responsible for meeting the standards. Because of these deficiencies, a comprehensive understanding of the true level of compliance with the standards and risk to the organization from non-compliance are not readily available.

Thus, there remains a need for a system, method, and software for establishing an inventory of standards and policies, evaluating the level of compliance with the standards, and resolving identified exceptions to the standards.

### SUMMARY OF THE INVENTION

Accordingly, the present invention is directed to a system and method for standards and governance evaluation framework that substantially obviates one or more problems due to limitations and disadvantages of the related art.

An object of the present invention is to provide a systems and methods to consolidate and maintain the standards of an organization.

Another object of the present invention is to provide systems and methods to tie the standards to the objects to which they apply (e.g., people, divisions, departments, buildings, equipment, etc.—collectively referred to as “assets”).

Another object of the present invention is to provide systems and methods to evaluate the operational risk to an organization by determining the level of compliance with the standards. Yet another object of the present invention is to provide systems and methods to view exceptions to the standards and to track trends of performance metrics for remediation.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a system includes a standards inventory database to store at least one control model, the at least one control model including at least one control objective and one or more controls, wherein each of the one or more controls is related to at least one asset of an organization, a tests datastore to store one or more control tests to be applied to the at least one asset of the organization, each of the one or more controls being associated with at least one of the one or more control tests, and a server including a testing tool to evaluate each of the one or more controls using the at least one of the one or more control tests associated with each of the one or more controls and to assign a status to the one or more control tests, and a metrics engine to track performance metrics of each of the one or more controls based on the status of the one or more control tests to provide trends in compliance with the one or more controls.

In another aspect, a method includes establishing a control structure, the control structure including at least one control model, the at least one control model including at least one control objective and one or more controls, wherein each of the one or more controls is related to at least one asset of an organization, associating one or more control tests to be applied to the at least one asset of the organization with each of the one or more controls, evaluating each of the one or more controls using at least one of the one or more control tests associated with each of the one or more controls, assigning a status to the one or more control tests, and tracking performance metrics of each of the one more controls based on the status of the one or more control tests to provide trends in compliance with the one or more controls.

In still yet another aspect, a computer program product includes a computer readable medium having stored thereon computer executable instructions that, when executed on a computer, configure the computer to perform a method including the steps of establishing a control structure, the control structure including at least one control model, the at least one control model including at least one control objective and one or more controls, wherein each of the one or more controls is related to at least one asset of an organization, associating one or more control tests to be applied to the at least one asset of the organization with each of the one or more controls, evaluating each of the one or more controls using at least one of the one or more control tests associated with each of the one or more controls, assigning a status to the one or more control tests, and tracking performance metrics of each of the one more controls based on the status of the one or more control tests to provide trends in compliance with the one or more controls.

It is to be understood that both the foregoing general description and the following detailed description are exemplary and explanatory and are intended to provide further explanation of the invention as claimed.

The specific examples provided herein are meant to be examples only and are not to be construed as limiting. It will be apparent to those skilled in the art that various modifications and variations can be made in the system and method for standards and governance evaluation framework of the present invention without departing from the spirit or scope of the invention.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a system diagram illustrating an exemplary embodiment of the present invention;

FIG. 2 is an exemplary logical data model of the present invention;

FIG. 3 is a flowchart illustrating an exemplary workflow in accordance with the present invention; and

FIGS. 4-12 illustrate exemplary graphical user interfaces in accordance with the present invention.

### DETAILED DESCRIPTION OF THE EMBODIMENTS

Reference will now be made in detail to the embodiments of the present invention, examples of which are illustrated in the accompanying drawings.

The systems and methods for standards and governance evaluation (“SAGE”) is designed to inventory standards and policies of an entity, to rate the risk of each of the standards or policies, to relate them to the entities to which they apply, and to plug into an evaluation mechanism to identify exceptions and track the exceptions through to resolution. The systems and methods of the present invention allow organizations to manage their standards. The systems and methods of the present invention also provide for the identification of the groups or individuals responsible for meeting these standards and for the tracking of compliance and remediation of exceptions to the standards.

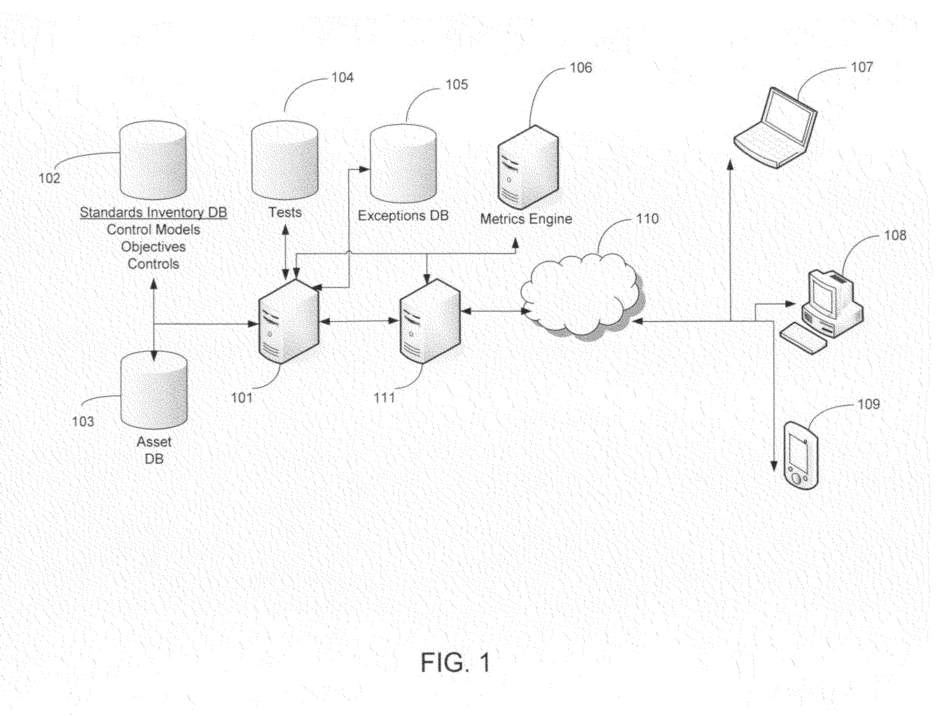

FIG. 1 shows a system diagram illustrating an exemplary embodiment of the present invention for creating a standards inventory, evaluating compliance with the standards, and resolving identified exceptions to the standards. As shown in FIG. 1, the exemplary system of the present invention includes database server 101 in communication with standards inventory database 102, asset database 103, tests datastore 104, and exceptions database 105. Database server 101 may include a database services management application that manages storage and retrieval of data from databases 102, 103, and 105 and datastore 104. Database server 101 additionally may communicate with any other data supplier to retrieve data. Databases 102, 103, and 105 and datastore 104 may be relational databases; however, other data organizational structure may be used without departing from the scope of the present invention.

The standards inventory database 102 stores the control models, control objectives, and controls. The asset database 103 stores information related to assets of an organization. For example, the information may relate to people, divisions, departments, buildings, equipment, and software applications. Assets or “auditable entities” represent activities or entities to which a control test applies. The control models, control objectives, and controls stored in the standards inventory database 102 are related to the assets (i.e., the entity to which they apply) stored in the asset database 103 through the use of relational database tables. Risk data, test frequency data, and other information related to the set up of a control are stored with the control in the standards inventory database 103. Examples of such data include notification to/cc/bcc information, notification templates, and whether to store key performance indicator metrics on exceptions.

In the exemplary embodiment shown in FIG. 1, the tests datastore 104 stores tests for evaluating whether a standard is being met. The tests may be stored in name-value/status pairs (e.g., Test1, Tested-Issues). The control stored in standards inventory database 102 that is being evaluated is related to the name-value/status pairs. For example, they may be related through the use of relational database tables. If the test is a query, then a SQL or stored procedure associated with a test is also stored in the tests datastore 104.

Exceptions data is generated when non-compliance of a standard is detected or identified. The exceptions data is stored in exceptions database 105. In some embodiments, the data in databases 102, 103, and 105 may be integrated into one or more databases.

In the exemplary embodiment of FIG. 1, application server 111 is in communication with database server 101. Application server 111 communicates requests for data to database server 101. Database server 101 retrieves the requested data. Application server 111 may also send data to database server for storage in databases 102, 103, and 105 and datastore 104. Application server 111 is also in communication with client devices 107, 108, and 109 over communication network 110. Application server 111 delivers software applications to client devices 107-109. Communication network 110 may be an internal network, such as a local area network (LAN), a wide area network (WAN), such as the internet, wireless networks (WiFi), cellular networks, or any combination thereof.

As shown in FIG. 1, client devices 107-109 may be a computer workstation, portable computer, personal computer, handheld devices, such as a personal digital assistant, cellular phone, or the like. In addition, client devices 107-109 may include any other device, such as a “dumb terminal” dedicated to communication and display of information only, that is convenient for establishing an inventory of standards and policies, evaluating of the level of compliance of the standards, and resolving identified exceptions. Client devices may be wired into the communication network 110 or may be wireless.

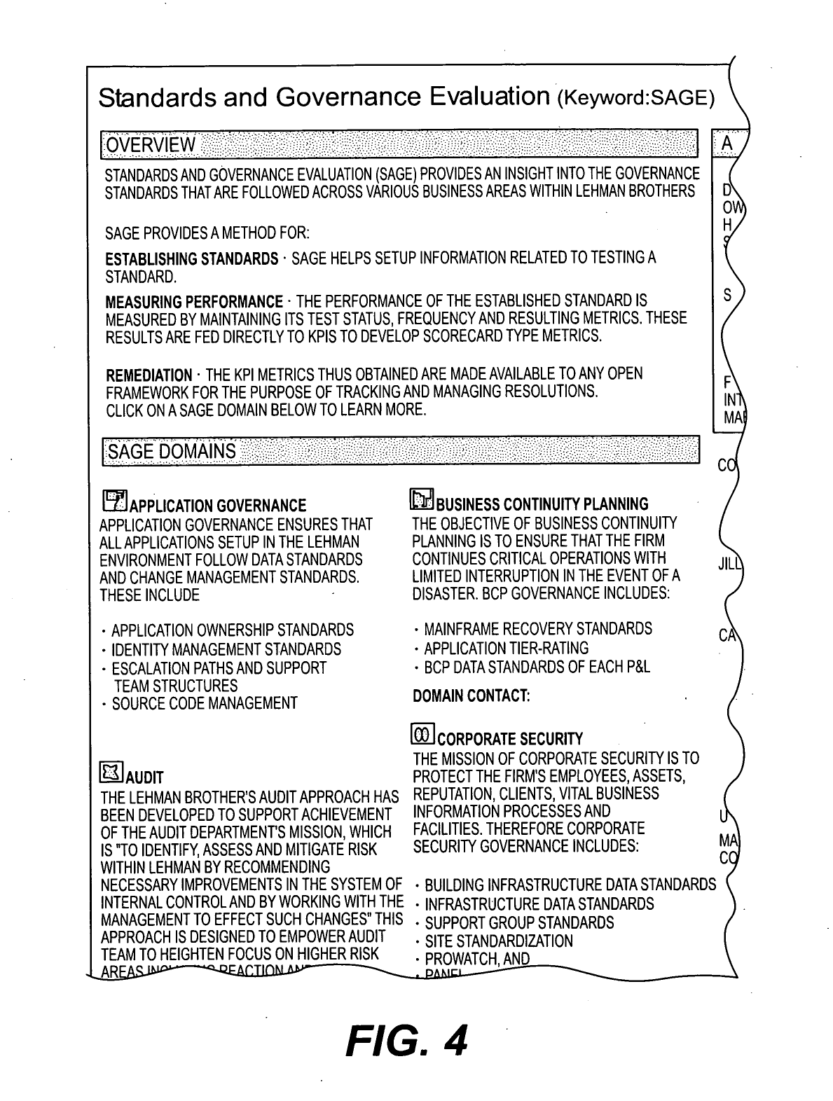

Client devices 107-109 may include a web browser or other graphical user interface as well as other computer applications. Examples of various interfaces are shown in FIGS. 4-12. When data or a particular application is requested by client devices 107-109 through an application, such as a web browser, the application server 111 receives and processes the request. The application server 111 sends the data or application requested to the client along with user interface instructions for displaying a user interface on client devices 107-109.

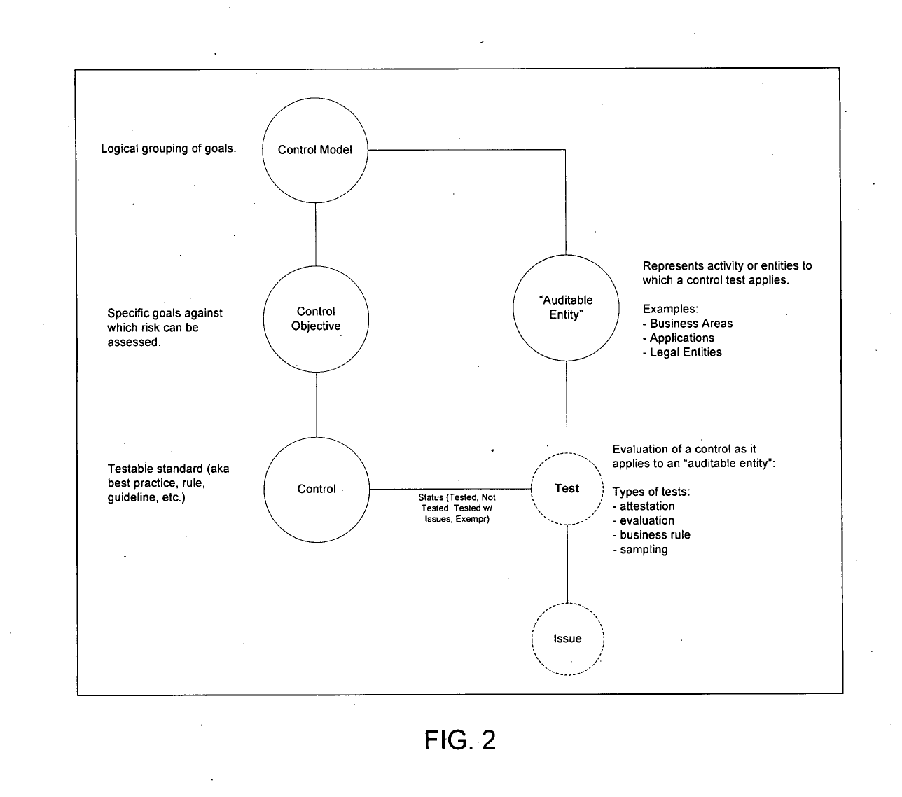

FIG. 2 shows an exemplary logical data model for an application that may be provided by application server 111 to client devices 107-109. In exemplary embodiment of the systems and methods for a SAGE framework in accordance with the present invention include three main components: 1) standards inventory; 2) evaluation; and 3) remediation. The first component, the standards inventory, establishes an inventory of standards and policies. The evaluation component includes evaluating the level of compliance with the standards. The remediation component includes resolving identified exceptions to the standards.

As shown in FIG. 2, an exemplary standards inventory in accordance with the present invention, which is also referred to as a control structure, includes control models, control objectives, and controls (i.e., standards). The standards inventory of an organization is to document standards, ownership of those standards, and to whom or what they should apply. A domain owner is able to create goals and objectives that apply to any appropriate asset or entity (e.g., person, group of people, building, system, etc.) as well as the specific standard (i.e., control), which are stored in the standards inventory. The standards may be indexed and transparent across business areas of an organization through the use of the standards inventory.

In an exemplary embodiment of the present invention, the control model is the broadest grouping and identifies a risk, cost, or benefit goal in general terms. The goal represents a general requirement that is easily understood by business users. For example, an organization may be required to maintain proper information barriers to control the flow of material, non-public information. This may be catalogued as a goal.

Since goals are general, by definition, they must be subdivided into a set of discrete objectives which, if achieved, meet the established goal. Control objectives may be applied to any area of an organization that conducts a specified activity. In some embodiments, control objectives are not specific to a particular business area.

The pursuit of an objective may require one or more specific steps to be taken by one or more groups, sometimes with interdependencies. In an exemplary embodiment, a control, also referred to as a standard, is a policy or requirement that satisfies a control objective for a business area or application. Controls may be defined by employees of an organization.

Controls are expressed in terms that can be tested. For example, the maintenance of a particular information barrier requires the identification of key data that can be used to distinguish those on one side of the barrier from those on the other. This data must then be used by a number of systems and processed to control the flow of information. Changes to the data must be properly communicated, and the overall process must be periodically reviewed for effectiveness. To determine the effectiveness of the process, various tests associated with defined standards may be performed.

Controls or standards also may be grouped into domains to allow for categorization. A domain is the group who owns, audits, and is responsible for tracking compliance with a set of standards. Examples of typical domains include Finance, Corporate Security, IT Security, Human Resources, Business Continuity Planning (BCP), and Audit.

Once a standard is defined, tools are provided to evaluate the standard by testing whether the standard is being met. The methods and systems of the present invention are used to influence the behavior of a diverse population where direct authority may not be a completely effective method for ensuring compliance with a strict set of standards. Testing is intended to demonstrate that the standard is effective over time and to adequately highlight the risk exposure if a standard is not met.

A control is tested using a control test. Since a control may apply to multiple business areas, a test may be conducted for each combination of control and business area. To develop a consistent metrics framework, each test is assigned a value during the period in which it is tested. For example, a test may be assigned one of the following four values: Tested, Tested—Issues, Exempt, or Not Tested. A status of Tested indicates that the business area meets the documented control standards with no significant issues detected. A status of Tested-Issues means that the asset or auditable entity, such as a business area, software application, or legal entity, was tested during the control period, but issues were raised and documented. Each test having this status is entered into a remediation tool and tracked using the remediation tool to resolve the issues. A status of Exempt means that an attribute of the asset or auditable entity obviates the need for testing during this period. A status of Not Tested means that a determination needs to be performed as to whether the status is Tested or Tested—Issues.

Tests may be executed in a number of ways, depending on the nature of the activity, the inherent risk, available resources, and other factors. The test method may also vary from period to period. Tests do not have to be conducted by a particular individual or in a specific way.

Examples of various testing methods include Manager Attestation, Evaluation, Business Rules, and Sampling or Cycling. For Manager Attestation, the manager of the business area is provided with documentation and resources to help him understand the control requirements and is asked to assert his group's compliance with those standards. This is the least invasive test and scales very well across a large organization. However, for Manager Attestation, standards need to be articulated such that untrained managers can conduct a self-assessment with minimal support. The manager sets the test status, and the audit manager is informed of the test status.

Evaluation includes an audit manager conducting an evaluation of the control for each business area in his domain. With this method, the audit manager sets the test status, and the business manager is informed of the test status.

The testing method Business Rules may be used in cases where compliance with a control is automatically detected by querying applications for the data that provides evidence of behavior. Many variations of this type of test may be used, including queries and automated tests. For example, if the control requires that a business area have documented business continuity procedures, a query that finds documents in the document repository that are appropriately tagged may be sufficient to prove compliance. Another example is if a control requires that application change events be processed by an organization's change management system, the existence of change tickets for the application may be used to demonstrate compliance with the control.

Some tests may be complicated, onerous, and critical, and therefore cannot be satisfied by the other methods of testing. The Sampling or Cycling testing method may be used. By randomly selecting a sample and conducting a comprehensive audit of the sample, the area of an organization responsible for controls may detect whether a complete evaluation is required. Alternatively, by evaluating a portion of an organization's business areas each period, ultimately evaluating all business areas over a number of periods, more onerous tests can be conducted more efficiently.

The systems and methods for SAGE framework in accordance with the present invention include a remediation component. This component is used for exception management and remediation and is focused on fixing the root cause of a problem, which manifests itself through non-compliance with a standard.

Various mechanisms may be used for remediation. For example, notification tools, a metrics engine, or a tool for exception management may be used. A notification may be sent to any or all of the following in the event of non-compliance with a control standard: control owner, entity owner (i.e., to which the standard applies), or any interested party. Non-compliance information may be fed to an external metrics engine based on testing frequency to determine metrics. Exception Management includes feeding exception data into an issue tracking tool for follow up. Any combination of the above can be used for any control standard.

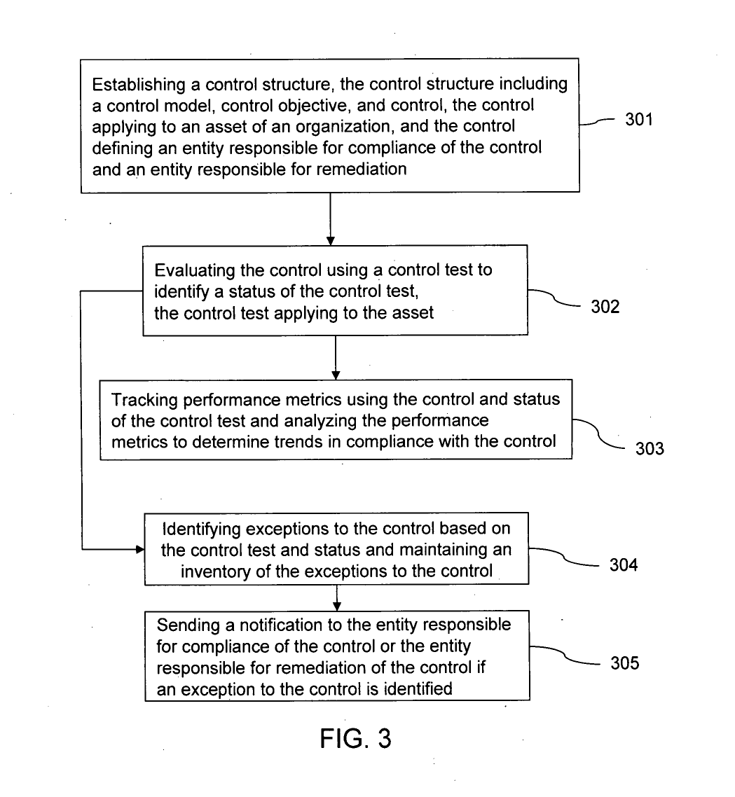

FIG. 3 is a flowchart illustrating an exemplary workflow in accordance with the present invention. The method includes a step of establishing an inventory of standards and policies. At step 301 of FIG. 3, a control structure or standards inventory is created. The control structure includes control models, control objectives, and the controls as described above.

In some embodiments, the control models, control objectives, and the controls are defined by a user. The user accesses an application, which is sent by application server 111 over communication network 110, using client devices 107-109. FIG. 4 is an example of an interface provided upon accessing the application. FIG. 4 includes a description of the SAGE framework as well as an inventory and description of domains.

An interface is provided by application server 111 for creating a control model. For example, a user, such as a domain owner, inputs information about the control model, such as the control model name and the domain of the control model, into the interface. The business owner, manager, and entitlement group information may also be inputted for a control model. After a user enters information into the interface regarding the control model, this information is transmitted over communication network 110 and stored in the standards inventory database 102.

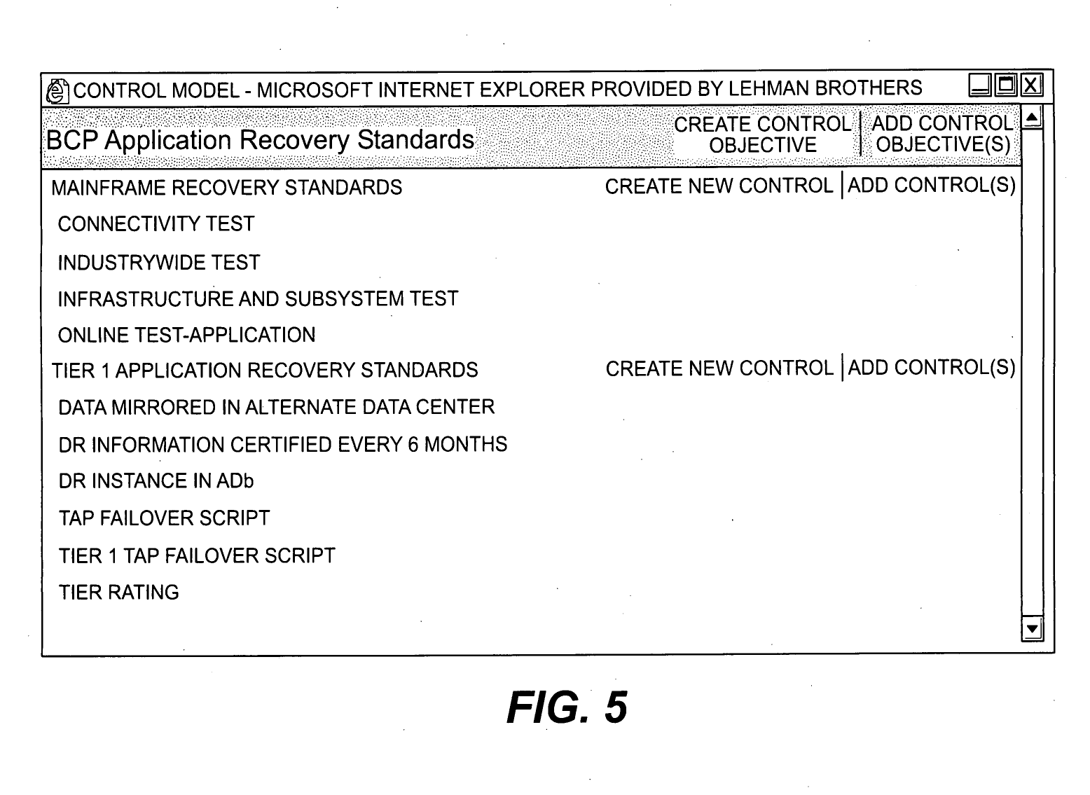

FIG. 5 provides an exemplary detailed view of a control model, which is stored in the standards inventory database 102. In FIG. 5, the top bar identifies the name of the control model. The objectives and control standards for the identified control model are provided below. Client devices 107-109 request the information about the control model, and application server 111 and/or database server 101 retrieve this information for display on the interface shown in FIG. 5.

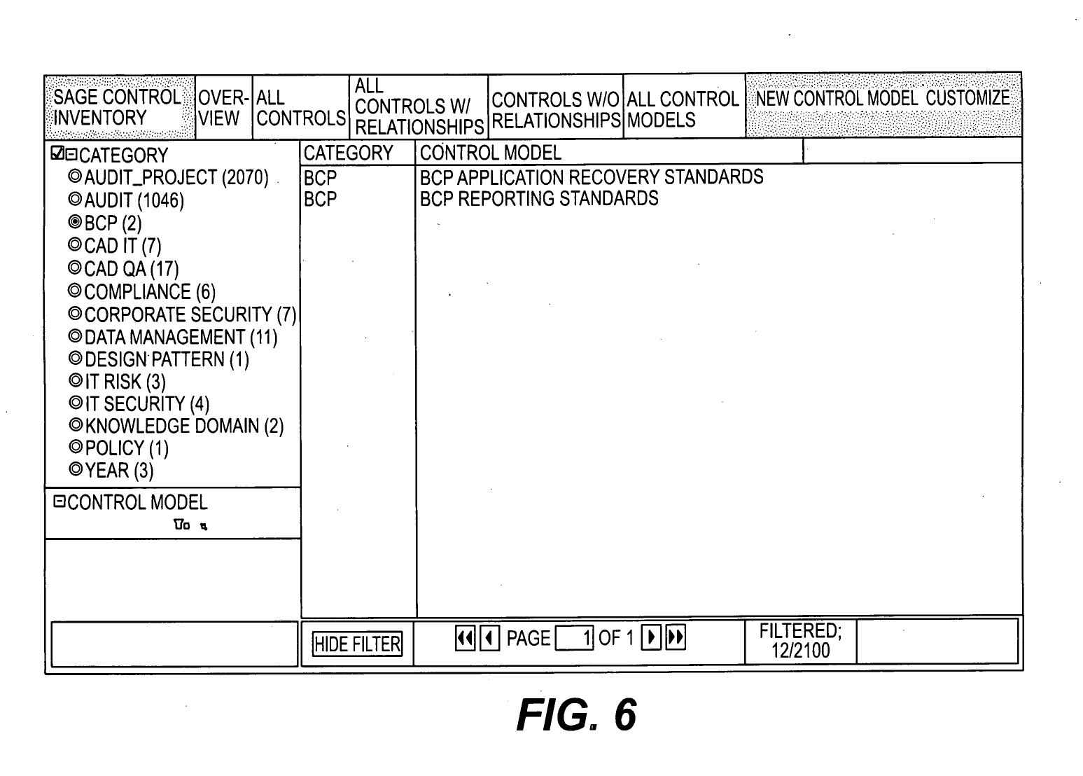

FIG. 6 is an exemplary interface for accessing and displaying an inventory of control models. In FIG. 6, the control models are categorized based on their respective domains (i.e., “Category” in FIG. 6). For example, as shown in FIG. 6, the control models that are associated with Business Continuity Planning (BCP) category are displayed.

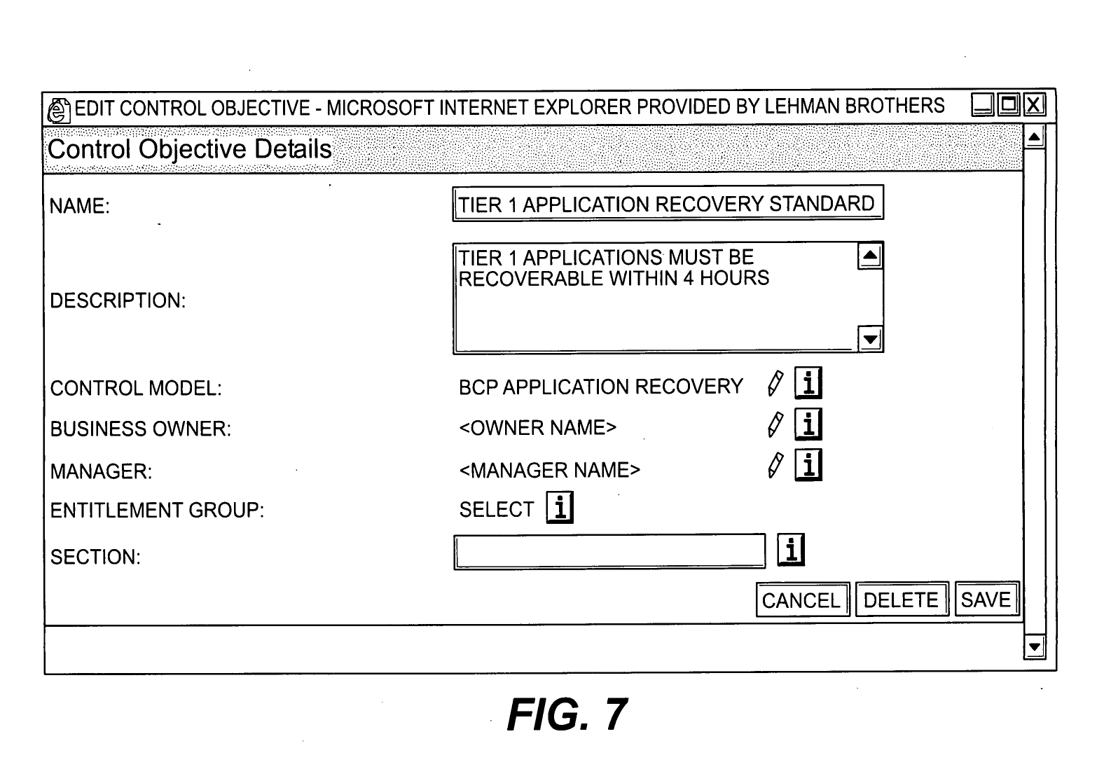

FIG. 7 is an exemplary user interface for creating and updating control objectives. A control objective is created and/or modified by defining data for the control objective, such as the control objective name and a description of the control objective, through the user interface shown in FIG. 7. The control objective is created for a specific control model. For example,

FIG. 5 illustrates that a control objective may be created for the specific control model displayed in a web browser. The business owner, manager, and entitlement group information shown in FIG. 7 may be automatically retrieved from the standards database 102 for the control objective based on the specific control model or based on the control associated with the control objective.

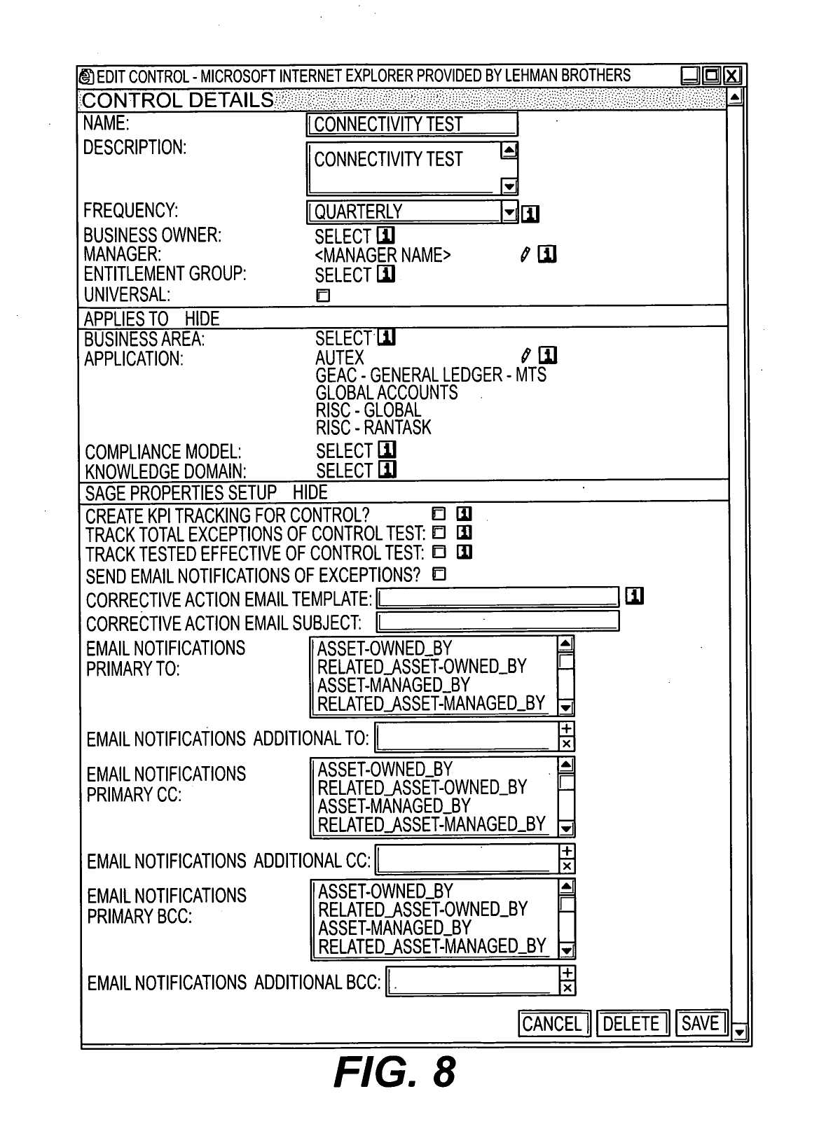

FIG. 8 is an exemplary user interface to create and update a control. Basic information about the control may be defined through the interface shown in FIG. 8, including the name, frequency of testing, and ownership, the entities associated with a control, and information about how to set up tests, notifications, and exception tracking. Each of the controls applies to an asset of the organization defined when the control is set up. The information may be transmitted from client devices 107-109 to application server 111 and database server 101 and stored in standards inventory database 102. In addition, the controls may be flagged to have metrics tracked. The exemplary interface shown in FIG. 8 allows a user to indicate whether metrics should be flagged for a control.

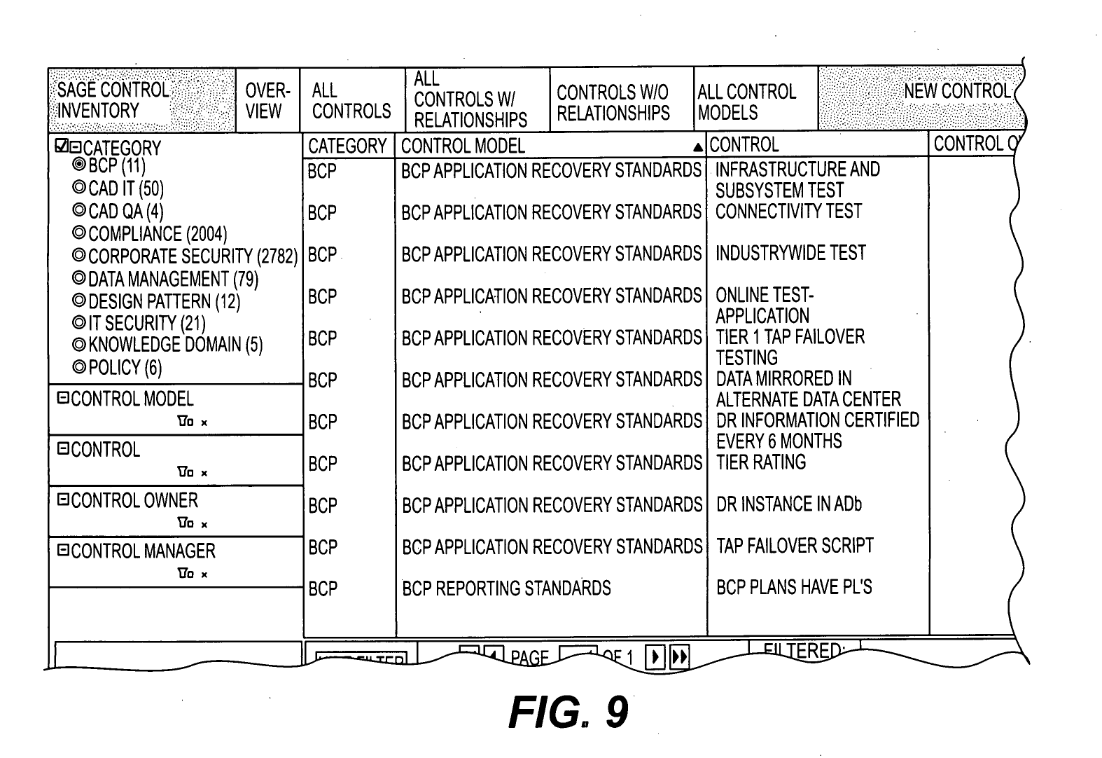

FIG. 9 shows an exemplary interface for an inventory of control standards, ownership of the control standards, related control models, and domains. Control objectives may also be displayed. The interface in FIG. 9 provides a mechanism to search for specific control models, controls, control owners, and control managers.

At step 302 of FIG. 3, a control is evaluated using a control test to identify a status of the control test. A control test is used to evaluate whether the control or standard is being met by the asset to which it applies. Control tests are created for the controls in the standards inventory database 102. For example, a manager of a business area may be provided with documentation and resources to help him understand the control requirements and may be asked to assert his group's compliance with those controls (i.e., manager attestation). An audit manager may conduct an evaluation of the control for each business area in his domain. If compliance with a control can be automatically detected by querying an application for the data that provides evidence of behavior, then the tests are created by a user. For example, if the test is a query, then the SQL logic or stored procedures are created and stored in test database 104. A test may be designed to sample a particular area, where a complete audit is done of the sample. A complete evaluation of the area may then be necessary. Alternatively, each business area may be evaluated periodically. All business areas may then be evaluated over a number of periods.

Once the control test is applied to a specific asset, a status of the control test, such as Tested, Tested-Issues, Exempt, and Not Tested, is assigned. The status may be assigned automatically by database server 101 or application server 111, or any other processor performing the test. The status of the control test is stored in the tests datastore 104 with the associated test. In other embodiments, the status of the control test may be stored in the standards inventory database 102 with the associated control.

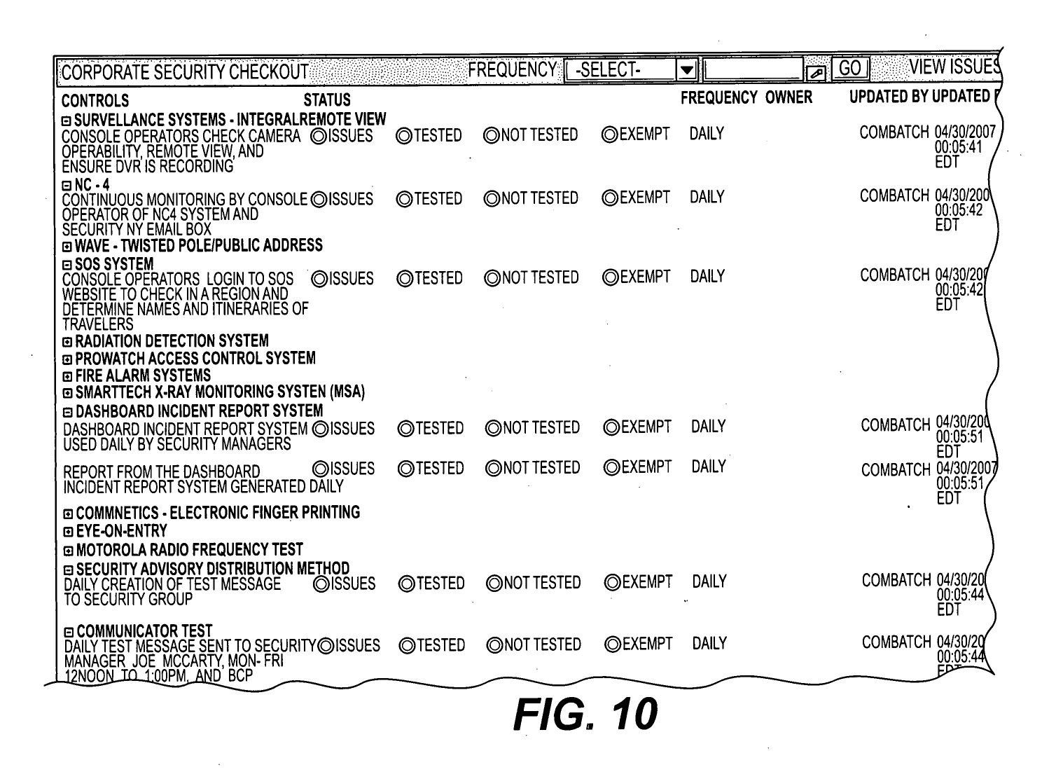

In some embodiments, the status may also be assigned by a system user. For example, if the control test is satisfied by performing a manager attestation, evaluation, or a sampling/cycling, a user interface is accessed through client devices 107-109. As shown in FIG. 10, a manager is able to input the status of the test on the appropriate frequency (e.g., daily, weekly). The user interface refreshes the control test status based on the frequency with which the attestation is required. A user may create a follow-on issue if appropriate.

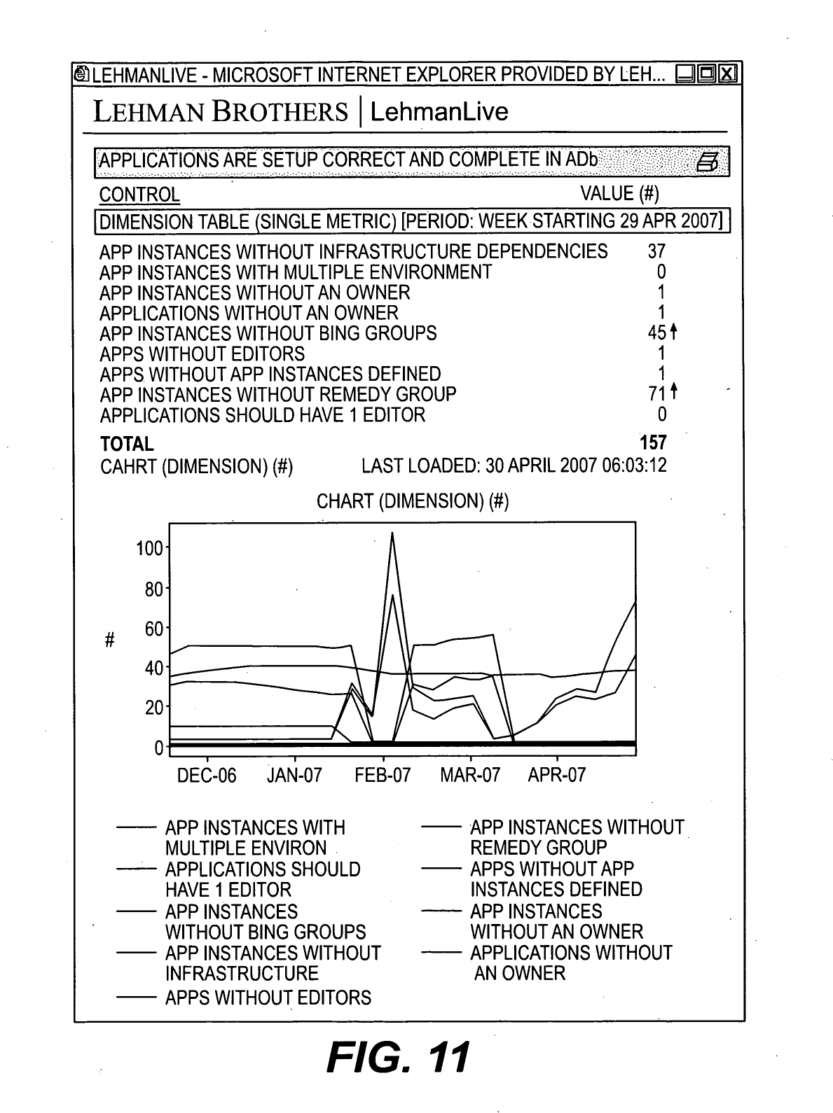

At step 303 of FIG. 3, performance metrics are tracked for a control. The metrics engine 106 of FIG. 1 running on a server may track the performance metrics. The metrics are tracked using parameters such as the control name, frequency of the control test, and the status of the control; however, other parameters may also be used without departing from the scope of the present invention. A sweep of the controls and their testing status may be performed by the metrics engine 106 to retrieve information from the standards inventory database 102, tests datastore 104, and/or exceptions database 105. The sweep may be performed at various time periods, for example, hourly or daily. The time periods may be based on the testing frequency. The information retrieved by the metrics engine may be stored in a database or other memory of the server running the metrics engine. The test results of the control test may be fed directly to key performance indicators to create scorecard type information, such as that shown in FIG. 11.

At step 303 of FIG. 3, the metrics are analyzed to determine trends in compliance with the control. For example, the metrics engine 106 may analyze the metrics to trend the control information, such as the control status, over time. Compliance with the control standard can then be tracked over time. The control metrics may be grouped by control model.

FIG. 11 is an exemplary interface for tracking and analyzing the metrics. The interface displays various metrics and their trends over time. The metrics may be displayed in any convenient form, such as data tables, spreadsheets, or other types of graphs (e.g., pie charts or bar graphs).

At step 304 of FIG. 3, exceptions to the control are identified based on the control test and status of the test. The exceptions data is stored in the exceptions database 105 to create an inventory of exceptions to controls. The inventory of exceptions to the controls is used to remediate issues in an organization related to compliance with the controls and to assess risks to the organization.

Database server 101, application server 111, or another processor may identify the exceptions based on the status of the control test. Database server 101 or application server 111 may retrieve information, such as the name of the control and the status, from the standards inventory database 102 for storage in the exceptions database 105.

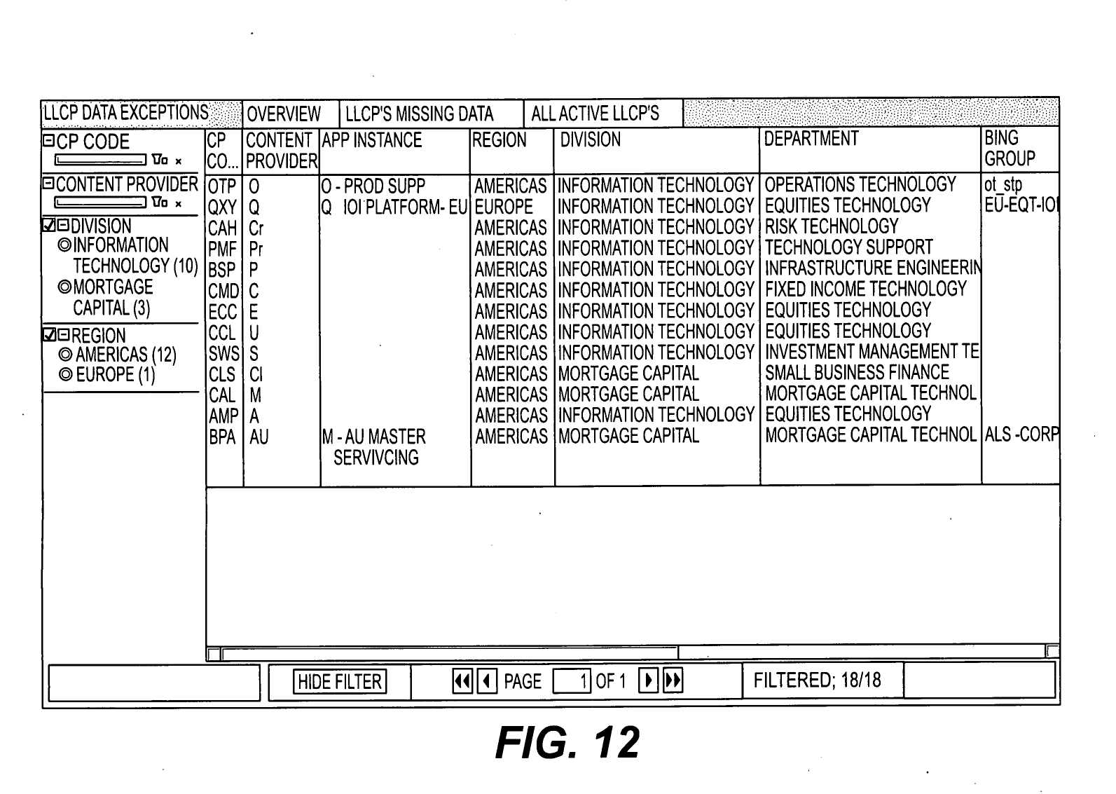

FIG. 12 illustrates an exemplary user interface for tracking exceptions stored in the exceptions database 105. For example, the user interface allows searching for exceptions based on a code, content provider, division, or region. Other search criteria may be used. The exceptions data and other test results data may be sent to any open framework or workflow tool for tracking.

At step 305 of FIG. 3, a notification is sent to the entity responsible for compliance of the control or the entity responsible for remediation of the control if an exception to the control is identified. The notification may also be sent to other interested parties. The notifications may be sent based on the role of the entity in the organization rather than by specific name. In the exemplary interface shown in FIG. 8, for example, a user is able to enter information about who the notifications are to be sent to. This information is stored in the standards inventory database 102 along with the control and is used to send the notification. In an exemplary embodiment, the notifications are sent via electronic mail. However, other forms of communication may be used, such as text messaging. In various embodiments, the database server 101 and/or application server 111 identifies the exceptions and transmit the electronic messages to an email server for distribution to client devices 107-109.

The systems and methods for SAGE framework in accordance with the present invention may provide many benefits to organizations. First, all of the standards of an organization may be consolidated into a central system. This consolidation prevents the standards and associated information from being stored in disparate systems or formats. Second, the standards of an organization can be related to the people, divisions, assets or entities that are required to comply with the standards. Third, risk ratings and metrics provide a view into the operational risk to an organization when a standard falls into exception (i.e., the standard is not complied with). For example, the lack of compliance with certain standards by an organization may put the organization or its employees at great risk and identifying these risks is important to the organization. Last, open exceptions and metric trends can be tracked and accessed by system users to determine if compliance is increasing or decreasing over time. Further, trends and statistics related to compliance may be used to determine if the standards are appropriate for a given population and to identify repeated violators of the standards.

It will be apparent to those skilled in the art that various modifications and variations can be made in the system and method for standards and governance evaluation framework of the present invention without departing from the spirit or scope of the invention. Thus, it is intended that the present invention cover the modifications and variations of this invention provided they come within the scope of the appended claims and their equivalents.

What is claimed is:

1. A system, comprising:
a standards inventory database to store at least one control model, the at least one control model including at least one control objective and one or more controls, wherein one or more of the controls are each related to at least one asset of an organization;
a tests datastore to store one or more control tests to be applied to the at least one asset of the organization, one or more of the controls each being associated with at least one of the one or more control tests; and
a server including
a testing tool to evaluate the one or more controls using the one or more control tests associated with the one or more controls and to assign a status to the one or more control tests, and
a metrics engine to track performance metrics of the one or more controls based on the status of the one or more control tests to provide trends in compliance with the one or more controls.

2. The system of claim 1 further comprising one or more client devices to create the at least one control model, the at least one control objective, and the one or more controls.

3. The system of claim 1 further comprising one or more client devices to access the performance metrics.

4. The system of claim 1 further comprising an exceptions database to store an exception identified based on the status of the one or more control tests.

5. The system of claim 4 further comprising one or more client devices to define an entity responsible for compliance and an entity responsible for remediation of the one or more controls.

6. The system of claim 5 further comprising a communications module to send a notification of the exception to the entity responsible for compliance or the entity responsible for remediation.

7. The system of claim 1 further comprising an asset database to store data of the at least one asset of the organization.

8. The system of claim 1, wherein the at least one asset of the organization is a person, a division, a department, a building, equipment, or a computer application.

9. The system of claim 1, wherein the one or more control tests are automatically performed by the server.

10. The system of claim 1, wherein the status of the one or more control tests includes tested, tested with issues, not tested, and exempt from testing.

11. A method, comprising:
establishing a control structure, the control structure including at least one control model, the at least one control model including at least one control objective and one or more controls, wherein one or more of the controls are each related to at least one asset of an organization;
associating each of one or more of the controls with one or more control tests to be applied to the at least one asset of the organization;
evaluating the one or more controls using the one or more control tests associated with the one or more controls;
assigning a status to the one or more control tests; and
tracking performance metrics of the one more controls based on the status of the one or more control tests to provide trends in compliance with the one or more controls.

12. The method of claim 11 further comprising identifying an exception to the one or more controls based on the status of the one or more control tests.

13. The method of claim 12 further comprising storing the exception in an exceptions database.

14. The method of claim 12 further comprising defining an entity responsible for compliance and an entity responsible for remediation of the one or more controls.

15. The method of claim 14 further comprising sending a notification of the exception to the entity responsible for compliance or the entity responsible for remediation.

16. The method of claim 11 further comprising storing data of the at least one asset of the organization in an asset database.

17. The method of claim 11, wherein the at least one asset of the organization is a person, a division, a department, a building, equipment, or a computer application.

18. The method of claim 11, wherein the one or more control tests are automatically performed by a server.

19. The method of claim 11, wherein the status of the one or more control tests includes tested, tested with issues, not tested, and exempt from testing.

20. A computer program product including a computer readable medium having stored thereon computer executable instructions that, when executed on a computer, configure the computer to perform a method comprising the steps of:
establishing a control structure, the control structure including at least one control model, the at least one control model including at least one control objective and one or more controls, wherein one or more of the controls are each related to at least one asset of an organization;
associating each of one or more of the controls with one or more control tests to be applied to the at least one asset of the organization;
evaluating the one or more controls using the one or more control tests associated with the one or more controls;
assigning a status to the one or more control tests; and
tracking performance metrics of the one more controls based on the status of the one or more control tests to provide trends in compliance with the one or more controls.

21. The computer program product of claim 20 further including computer executable instructions that, when executed by the computer, configure the computer to perform the step of identifying an exception to the one or more controls based on the status of the one or more control tests.

22. The computer program of claim 21 further including computer executable instructions that, when executed by the computer, configure the computer to perform the step of storing the exception in an exceptions database.

23. The computer program of claim 21 further including computer executable instructions that, when executed by the computer, configure the computer to perform the step of defining an entity responsible for compliance and an entity responsible for remediation of the one or more controls.

24. The computer program of claim 23 further including computer executable instructions that, when executed by the computer, configure the computer to perform the step of sending a notification of the exception to the entity responsible for compliance or the entity responsible for remediation.

25. The computer program of claim 20 further including computer executable instructions that, when executed by the computer, configure the computer to perform the step of storing data of the at least one asset of the organization in an asset database.

26. The computer program product of claim 20, wherein the at least one asset of the organization is a person, a division, a department, a building, equipment, or a computer application.

27. The computer program of claim 20, wherein the one or more control tests are automatically performed by a server.

28. The computer program of claim 20, wherein the status of the one or more control tests includes tested, tested with issues, not tested, and exempt from testing.
